(19) United States
(12) Patent Application Publication
(10) Pub. No.: US 2026/0086806 A1
(43) Pub. Date: Mar. 26, 2026

(54) PROGRAMMATIC GLOBAL PARAMETER ENFORCEMENT

(71) Applicant: Truist Bank, Charlotte, NC (US)

(72) Inventor: Matthew Laine Donlan, Charlotte, NC (US)

(73) Assignee: Truist Bank, Charlotte, NC (US)

(21) Appl. No.: 18/897,756

(22) Filed: Sep. 26, 2024

(51) Int. Cl. G06F 9/30; G06F 11/30; G06F 11/34

(52) U.S. Cl. CPC G06F 9/30072; G06F 11/3024; G06F 11/3419

(57) ABSTRACT

In one aspect, a method, includes receiving, by a controller application executing on a processor, telemetry data from a plurality of data sources of a system, determining, by the controller application, one or more thresholds associated with the system, determining, by the controller application, an action based on the telemetry data and the one or more thresholds, generating, by the controller application, a plurality of instructions to implement the action, wherein respective ones of the plurality of instructions are associated with respective ones of the plurality of data sources, and initiating, by the controller application, performance of the plurality of instructions to implement the action in the system.

### BACKGROUND

Various entities may have numerous hardware and/or software systems for computer processing operations. However, these systems are often disparate, as a given entity may develop some solutions internally while contracting with third parties who provide other solutions. As such, the ability to control operations on a global level is constrained, as each solution requires specific customization. As such, conventional solutions are largely manual, inefficient, and expose the associated entities with legal, compliance, and/or security risks.

### BRIEF SUMMARY

Embodiments of the present disclosure address the above needs and/or achieve other advantages by providing apparatuses and methods that programmatically enforce global parameters.

In various embodiments, a method involves receiving telemetry data from multiple data sources via a controller application on a processor. The controller application determines thresholds associated with the system and determines actions based on this data and the established thresholds. It then generates instructions tailored to each data source, which when executed by the processor, implement these actions in the system.

Additionally, a non-transitory computer-readable storage medium may contain code that, upon execution by a processor, directs the controller application to receive telemetry data from various sources. The controller application determines thresholds and corresponding actions based on this data. The controller application generates specific instructions associated with each source for implementing these actions within the system.

Furthermore, an embodiment of the method also includes collecting telemetry data by an application running on a processor at one or more data sources. The collected data is transmitted to a controller, which in turn provides a set of instructions designed to carry out measures for each data source upon receiving them from the controller. This ensures that the actions taken are directly related to the telemetry information gathered and are appropriately targeted at improving system performance where necessary.

The features, functions, and advantages that have been discussed may be achieved independently in various embodiments of the present disclosure or may be combined in yet other embodiments, further details of which can be seen with reference to the following description and drawings.

### Brief Description of the Several Views of the Drawings

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates a system 100 in accordance with one embodiment.

FIG. 2A illustrates an aspect of the subject matter in accordance with one embodiment.

FIG. 2B illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a logic flow 500 in accordance with one embodiment.

FIG. 6 illustrates a logic flow 600 in accordance with one embodiment.

FIG. 7 illustrates a computing system 700 in accordance with one embodiment.

### DETAILED DESCRIPTION

Embodiments disclosed herein provide solutions to programmatically enforce system-wide parameters across multiple disparate systems associated with an entity. The parameters may include any type of parameters, such as rules, thresholds, and priority values. Telemetry data may be collected throughout the system. The parameters may be updated based on the collected telemetry data. Because enterprise systems have different hardware configurations, operating systems, applications, services, etc., enforcement of parameters in disparate conventionally required manual configuration of each type of entity, which is costly in terms of time and/or resources.

Advantageously, embodiments disclosed herein allow parameters to be enforced across disparate entities in a system. One example of a parameter is a liquidity parameter. The liquidity of an entity may be computed by dividing total assets by total liabilities. In some embodiments, a controller may enforce one or more liquidity parameters of using one or more thresholds and/or rules. For example, the controller may implement various liquidity thresholds and rules indicating when to apply a given threshold, how to prioritize transactions, etc. The controller may further be configured to interact with different applications, devices, or other computing resources in an enterprise system. For example, the controller may be configured to translate instructions and/or other operations such that the instructions and/or operations are compatible with a target system (whether the target system is implemented hardware, software, or a combination of hardware and software). Furthermore, the controller may receive telemetry data from various sources in the system to facilitate the enforcement of parameters. For example, the telemetry data may reflect pending and/or processed transactions. The controller may aggregate the telemetry data received from the data sources, which allows the controller to maintain constant, real-time insight into the liquidity of the entity.

Advantageously, embodiments disclosed herein allow parameters of an entity to be globally managed and enforced across disparate systems. For example, one or more liquidity parameters may be enforced across systems that allow funds (or other assets) to be transferred. By aggregating telemetry data gathered by various data sources in the system, the controller maintains an accurate view of the current liquidity (and overall state) of the entity. Furthermore, by translating various instructions or commands into specific formats, the controller is able to communicate with any type of component in the system. Doing so improves the functioning of all devices and software in the system, as parameters of the entity can be managed in real-time across all different types of hardware and/or software. Furthermore, doing so saves time and computing resources required to manually configure various applications, systems, etc., to enforce parameters. Embodiments are not limited in these contexts.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the disclosure and enable one of ordinary skill in the art to make, use, and practice the disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

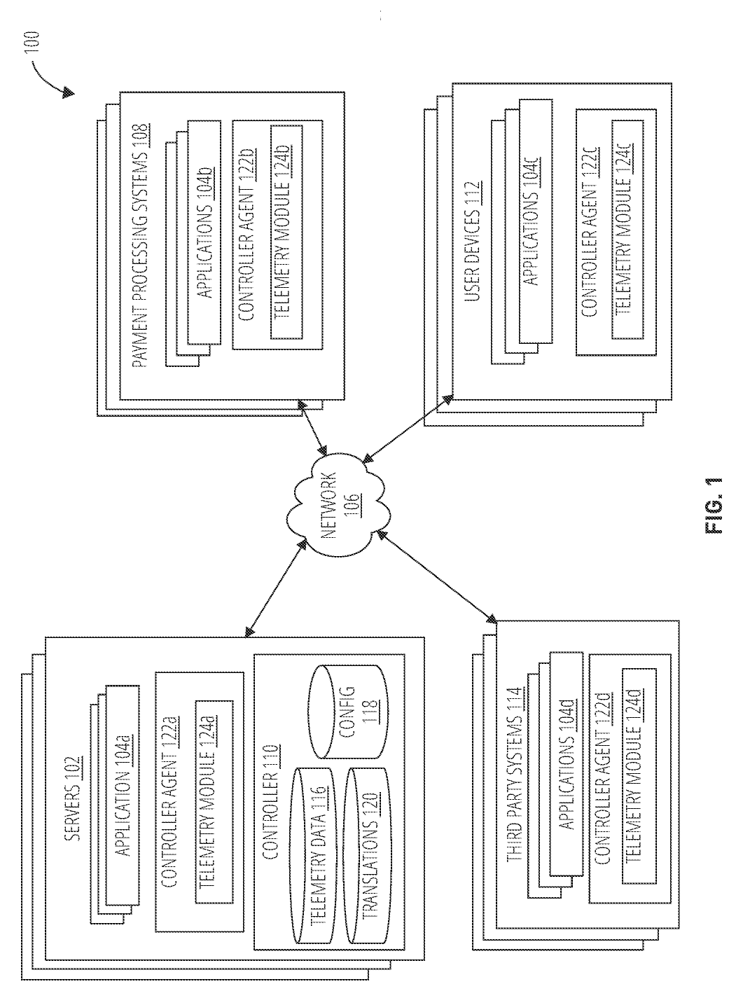

FIG. 1 illustrates a system 100 provides programmatic global parameter enforcement, according to one embodiment. As shown, the system 100 includes one or more servers 102, one or more payment processing systems 108, one or more user devices 112, and one or more third party systems 114 communicably coupled via one or more networks 106. The servers 102, payment processing systems 108, user devices 112, and/or third party systems 114 are representative of any type of physical and/or virtualized computing system.

As shown, the servers 102 may store or otherwise host a plurality of applications 104a, the payment processing systems 108 may store or otherwise host a plurality of applications 104b, the user devices 112 may store or otherwise execute a plurality of applications 104c, and the third party systems 114 may store or otherwise host a plurality of applications 104d. The applications 104a-104d are representative of any number and type of application. For example, the applications 104a-104d may include web browsers, account management applications, mobile P2P payment system client applications, applications provided by financial institutions, financial applications, payment applications, Automated Clearing House (ACH) applications, FedNow payment applications, real-time payments (RTP) applications, monetary transfer applications, mobile wallet applications, accounting applications, payment processing frameworks, etc. Although depicted as applications, the applications 104a-104d may are representative of any type of executable code, such as services, microservices, application programming interfaces (APIs), etc. Regardless of the type of a given application 104a-104d, in some embodiments, the applications 104a-104d may include features to process at least a portion of a transaction. The transactions may include purchases, payments, equity transactions, cryptocurrency sales, or any type of transaction. Furthermore, a given transaction may be processed at least in part by multiple applications 104a-104d.

The applications 104a-104d may interact with various databases (not pictured), such as account databases for customer accounts, databases for payment accounts, production databases for applications, financial institution databases, databases for cached data, and databases for files such as those for user accounts, user profiles, account balances, and transaction histories, files downloaded or received from other devices, and other data items and the like. Example accounts include a checking account, a savings account, a money market account, a certificate of deposit, a mortgage or other loan account, a retirement account, a brokerage account, or any other type of account.

As shown, the servers 102 includes a controller 110. The controller 110 is generally configured to programmatically implement global parameter enforcement via the functionality described herein. The payment processing systems 108, the user devices 112, and the third party systems 114 each include a respective instance of a controller agent 122a-122c. The controller agents 122a-122c are configured to communicate with the controller 110 to implement the techniques described herein. Although depicted as executing on a server 102 that hosts applications 104a, in some embodiments, the controller 110 may execute on one or more of the servers 102 that does not host applications 104a. The controller 110 may communicate with one or more controller agents 122a-122d in the system 100. A given system 100 may have one or more instances of the controller 110. In embodiments where multiple instances of the controller 110 are present, these instances of the controller 110 may communicate information to provide the functionality described herein. For example, the instances of the controllers 110 may exchange telemetry data 116, translations 120, and/or configurations 118. Embodiments are not limited in these contexts.

In some embodiments, the servers 102, user devices 112, and/or payment processing systems 108 may be associated with an entity, such as a financial institution. Similarly, the third party systems 114 may be associated with one or more third parties. In some embodiments, the servers 102, user devices 112, payment processing systems 108, and the third party systems 114 may be part of a payment processing network (also referred to as “payment rails”). Therefore, in some embodiments, one or more of the third party systems 114 are payment processing systems (such as the payment processing systems 108) that are managed by third parties.

For example, a financial institution may maintain or otherwise be associated with the servers 102, payment processing systems 108, and/or user devices 112 (and/or subsets thereof). As stated, one or more of the servers 102, user devices 112, payment processing systems 108, and third party systems 114 may be part of a payment processing network (not pictured). Therefore, the network 106 may be representative of a private enterprise network, while the entities in the enterprise network connect to external entities (e.g., one or more of the payment processing systems 108 and/or the third party systems 114) via a public network (e.g., the Internet).

As shown, the controller 110 includes data stores for telemetry data 116, translations 120, and configuration 118. Although depicted as databases, the telemetry data 116, translations 120, and/or configuration 118 may be stored in any type of data structure. The telemetry data 116 stores telemetry data captured by one or more data sources (e.g., the telemetry modules 124a-124d of the controller agents 122a-122d). The telemetry data captured by the telemetry modules 124a-124d may include any data describing the applications 104a0-104d and/or the devices these applications 104a-104d execute on. The telemetry modules 124a-124d may be implemented in hardware, software, or a combination of hardware or software. The telemetry modules 124a-124d are generally configured to monitor and record information describing operations performed by the hardware and/or software entities in the system 100. For example, the controller agents 122a-122d may include software to identify transactions processed by the applications 104a-104d, transactions processed by the servers 102, payment processing systems 108, user devices 112, and/or third party systems 114. The controller agents 122a-122d may be configured to capture predetermined attributes of a given operation being monitored. For example, for transactions, the controller agents 122a-122d may identify payor accounts, payee accounts, transaction amounts, currency type, date, etc.

In at least one embodiment, the telemetry data collected by the telemetry modules 124a-124d includes data describing processed transactions by the applications 104a-104d, the servers 102, the payment processing systems 108, the user devices 112, and/or the third party systems 114. For example, the data describing the transactions may include timestamps, associated accounts (e.g., a payor account funding the transaction and a payee account as recipient of the transaction), transaction type (e.g., incoming payment, outgoing payment, product purchase, loan, equity sale, etc.), currency type, and/or transaction amount. For example, if an application 104c processes a transaction where a first user pays a second user $20 for lunch, metadata describing the transaction (e.g., the accounts of the first and second users, that the first user paid the second user $20, a timestamp, etc.) may be stored collected by the controller agent 122c executing on the first user's device and/or the second user's device and stored in the telemetry data 116. Embodiments are not limited in these contexts.

The configuration 118 generally includes parameters to be enforced in the system 100. The parameters may include thresholds, rules, priority levels, actions, or any other configurable parameter. A given parameter may be associated with one or more entities in the system 100. For example, a global liquidity threshold may specify a liquidity ratio that must be enforced such that the transactions processed by the system 100 do not exceed the liquidity ratio. Example global liquidity thresholds include ratios of 1.10. 2.50, etc. However, any value may be used as a ratio, threshold, etc.

A given entry in the configuration 118 may further include one or more associated rules and/or actions. Continuing with the previous example, the global liquidity threshold may be associated with rules that specify to reject a transaction if the liquidity of the entity would be above or below (or otherwise violate) the global liquidity threshold if the transaction were processed. As another example, the global liquidity threshold may be associated with rules that specify to approve a transaction if the global liquidity threshold would not be exceeded if the transaction were processed. As yet another example, the global liquidity threshold may be associated with rules that specify to transmit a notification to one or more recipients if the global liquidity threshold is exceeded. Therefore, the controller 110 and/or the controller agents 122a-122d are configured to compute liquidity values, make comparisons, and perform other operations to support the embodiments disclosed herein. Embodiments are not limited in these contexts.

In some embodiments, the configuration 118 may include priority values for types of operations, types of applications, types of systems, types of transactions, etc. Doing so allows the controller 110 and/or the controller agents 122a-122d to enforce quality of service (QoS), e.g., by performing operations associated with higher priority values before operations associated with lower priority values.

In some embodiments, individual components in the system 100 may have associated parameters in the configuration 118. For example, a first application 104a (and/or a first type of application) may have a lower liquidity threshold (e.g., 1.5 when the global liquidity threshold is 2.0), while a second application 104b (and/or a second type of application) may have a higher liquidity threshold (e.g., 2.5 when the global liquidity threshold is 2.0). In some embodiments, the configuration 118 includes thresholds that are further associated with intervals of time (e.g., transactions per minute, amount of currency per transaction, amount of currency per hour, etc.). In some embodiments, a given entry in the configuration 118 may include one or more time intervals during which the entry is active (e.g., apply a global liquidity threshold of 2.0 from 8 AM to 5 PM on business days, applying a global liquidity threshold of 1.9 on weekends, etc.). In some embodiments, one or more parameters in the configuration 118 may be location-based. For example, different thresholds may be applied to different systems in different geographic locations.

The translations 120 is a data store including entries that specify one or more rules and/or operations for conversions between different types of entities in the system 100. Doing so allows the rules, thresholds, operations, and other data in the configuration 118 to be consumed by any type of hardware, software, or combination of hardware and software. For example, the translations 120 may include entries for converting code written in one programming language into another, enabling interoperability between diverse platforms. As another example, the translations 120 may include software environment translation entries for configuring different operating systems to execute one of the applications 104a-104d (e.g., when an application is not natively supported by an operating system, translating Windows® API calls for use in a Linux® environment, etc.). As another example, the translations 120 may include entries that specify API calls supported by entities in the system 100. As another example, the translations 120 may include entries for data format conversions (e.g., converting data between formats, such as JSON to XML or CSV to SQL, to ensure compatibility with different systems or applications). Yet another example of translations 120 includes translations between network protocols, e.g., such as translating between HTTP and MQTT, which allows devices using different communication standards to interact. Other examples of translations 120 include file format translations (e.g., PNG to JPEG, etc.), command translations, and machine learning model translations. Embodiments are not limited in these contexts.

In some embodiments, the configuration 118 and/or the translations 120 include computer-readable instructions that are executable to implement the parameters specified in the configuration 118. For example, instructions in the configuration 118 and/or the translations 120 may be executable to sever a network 106 and/or a portion thereof, disable one or more of the applications 104a-104d, approve the processing of a transaction, reject the processing of a transaction, shut down one or more of the servers 102, shut down specific processes within one or more of the application 104a-104d (e.g., disable a payment process, processes supporting the payment process, etc.). Therefore, using a set of instructions in the configuration 118 and/or the translations 120, software, machines, networks, and/or components can programmatically adhere to various parameters in the configuration 118 in an automated fashion. In some embodiments, one or more entries in the configuration 118 and/or the translations 120 may be predefined. In some embodiments, a user may create, delete, and/or modify entries in the configuration 118 and/or the translations 120.

The controller 110 may periodically share information with the controller agents 122a-122d, e.g., send indications of rules, thresholds, operations, instructions, priority values, etc., from the configuration 118 to the controller agents 122a-122d. For example, if a user defines a threshold of $1,000 per second of outgoing transactions (e.g., payments) processed by an application 104b in the configuration 118, the controller 110 may transmit an indication of the entry in the configuration 118 to the controller agent 122b. As stated, in some embodiments, the controller 110 may transform the entry in the configuration 118 based on the translations 120 for the target entity (e.g., the payment processing systems 108 and/or applications 104b, etc.). The controller agent 122b may then provide the indication of the entry to the application 104b and/or enforce requests received from the application 104b using the received data. As another example, when the user-defined entry is created in the configuration 118, the controller 110 may programmatically generate a corresponding entry in the translations 120 for the user-defined entry. In some embodiments, the user may specify the entry in the translations 120. The entry in the translations 120 may be transmitted to the controller agents 122a-122d in addition to the entry in the configuration 118. In some embodiments, the entry from the translations 120 is provided to the controller agents 122a-122d while the entry from the configuration 118 is not provided to the controller agents 122a-122d. The controller agents 122a-122d may therefore include instances of some or all of the data in the configuration 118 and/or translations 120 (not pictured for clarity). In some embodiments, the controller agents 122a-122d are pre-configured to include some or all of the data in the configuration 118 and/or translations 120, while receiving periodic updates of the same from the controller 110. Embodiments are not limited in these contexts.

Therefore, a given entity in the system 100 may be configured to interface with an instance of the controller agent 122a-122d when performing one or more operations. For example, the applications 104a-104d may include respective instances of the controller agents 122a-122d. As another example, the controller agents 122a-122d may be external to the applications 104a-104d. Doing so allows the configuration 118 to be enforced when the applications 104a-104d execute. For example, if a Zelle® application 104c receives an indication of a payment initiated by a user of a user device 112, the application 104c may request permission to process the payment from the controller agent 122c. The controller agent 122c may then permit or restrict processing of the payment based on one or more rules, thresholds, operations, etc., in the configuration 118 and/or translations 120. For example, if processing an outbound $1M payment would cause the liquidity of the financial institution to exceed a global liquidity threshold, the controller agent 122c may reject the transaction. As another example, if processing the outbound $1M payment would not cause the liquidity of the financial institution to exceed a global liquidity threshold, the controller agent 122c may permit the transaction. The controller agent 122c returns an indication of the determination to the requesting application 104c (e.g., permitting and/or rejecting processing of the transaction).

In some embodiments, the controller 110 may detect a triggering event to implement parameter enforcement. For example, if the liquidity ratio is approaching a threshold, the controller 110 may trigger the enforcement of one or more parameters in the configuration 118 to restrict one or more monetary transfers by the financial institution. As another example, the controller 110 may determine that the financial institution has assets that are below a threshold, and trigger enforcement of one or more parameters in the configuration 118 to restrict bi-directional monetary transfers by the financial institution.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 106 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The payment processing systems 108 and/or third party systems 114 may include automatic teller machines (ATMs) utilized by the system 100 in serving users. In another example, the payment processing systems 108 and/or third party systems 114 represent payment clearinghouse or payment rail systems for processing payment transactions, and in another example, the third party systems 114 such as merchant systems or banking systems configured to interact with the user devices 112 during transactions and also configured to interact with the enterprise system 100 (e.g., the servers 102 and/or payment processing systems 108) in back-end transactions clearing processes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 112) to serve users in their interactions to communicate and take action. In such embodiments, the user devices 112 can be, as non-limiting examples, computing devices, kiosks, terminals, smart devices such as phones, and devices and tools at customer service counters and windows at POS locations.

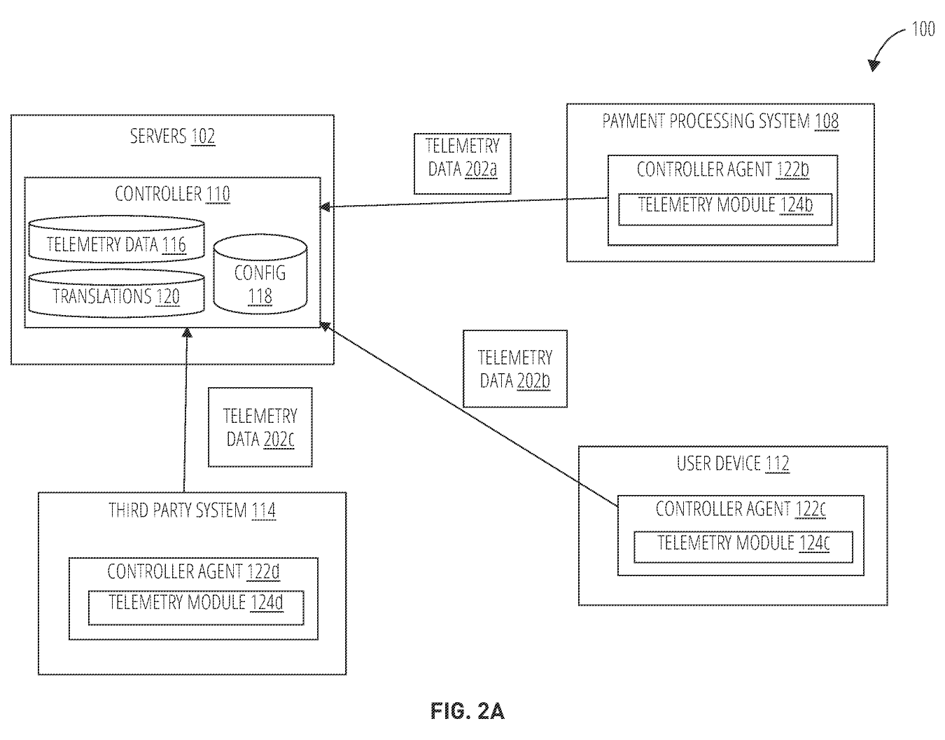

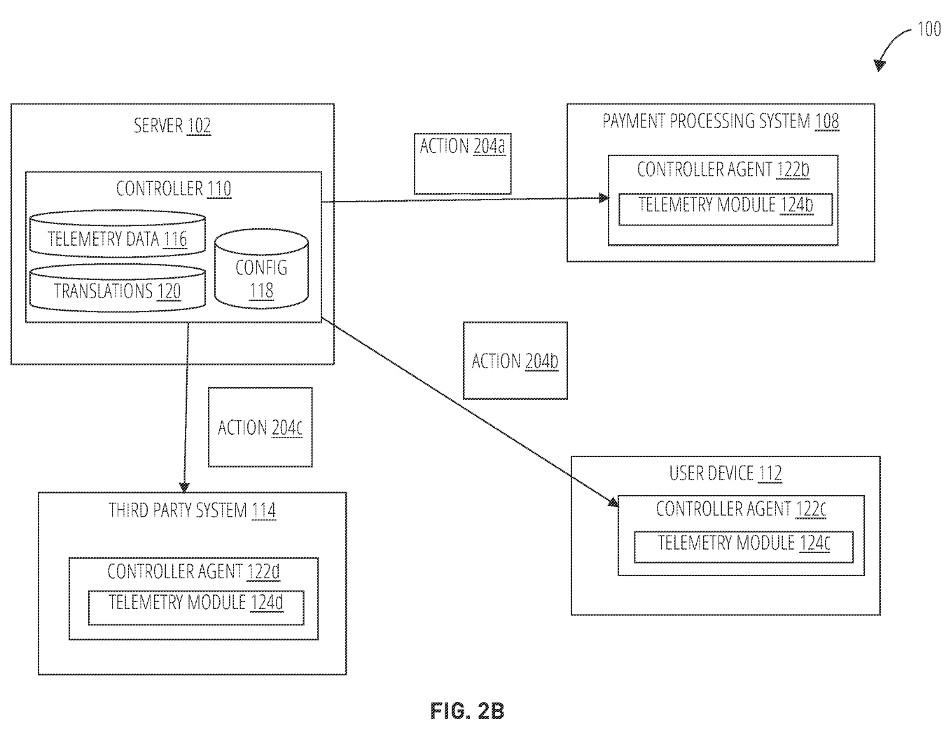

FIG. 2A is a schematic illustrating an example of programmatically enforcing system-wide parameters in the system 100, according to one embodiment. As shown, the controller agents 122b-122d of payment processing system 108, user device 112, and third party system 114 may capture indications of telemetry data 202a-202c. The telemetry data 202a-202c may describe any number and type of processing operations performed on the payment processing system 108, user device 112, and third party system 114 (e.g., using the applications 104b-104d), etc. For example, the telemetry data 202a may be for one or more transactions processed using one or more of the applications 104b, the telemetry data 202b may be for one or more transactions processed using one or more of the applications 104c, and the telemetry data 202c may be for one or more transactions processed using one or more of the applications 104d.

The controller 110 may receive the indications of telemetry data 202a-202c and store the same in the telemetry data 116. The controller 110 may further process the received telemetry data 202a-202c, e.g., to update assets, liabilities, liquidity values, balances, etc. In some embodiments, the controller 110 may determine one or more actions in response to the receipt and/or processing of the telemetry data 202a-202c. In some embodiments, the actions may include the controller 110 selecting one or more rules, thresholds, operations, etc., from the configuration 118. For example, if the processing of the telemetry data 202a-202c indicates the liquidity of the associated financial institution has fallen below a threshold liquidity value, the controller 110 may determine to restrict processing of transactions exceeding a predetermined dollar amount. The controller 110 may then translate the action based on the translations 120, e.g., to ensure the actions are consumable by the target entities (e.g., servers 102, payment processing systems 108, user devices 112, third party systems 114, applications 104a-104c, etc.). Embodiments are not limited in these contexts.

FIG. 2B illustrates an embodiment where the controller 110 transmits indications of one or more actions to the controller agents 122b-122d. As shown, the controller 110 transmits an indication of at least one action 204a to controller agent 122b, an indication of at least one action 204b to controller agent 122c, and an indication of at least one action 204c to controller agent 122d. The actions 204a-204c may include rules, thresholds, parameters, executable instructions, etc. As stated, in some embodiments, the actions 204a-204c are generated based on the translations 120 to ensure compatibility with a target system and/or application. The actions 204a-204c may the same actions or different actions. For example, the actions 204a may specify to restrict outbound currency transfers by the applications 104b, while actions 204c may specify to restrict all currency transfers by applications 104d. Embodiments are not limited in these contexts.

Once received, the controller agents 122b-122d may store the actions 204a-204c, execute the actions 204a-204c, process the actions 204a-204c, etc. More generally, the controller agents 122b-122d may enforce the actions 204a-204c, e.g., by applying thresholds, parameter configurations, processing requests to process transactions, etc. For example, controller agent 122b may receive a request from application 104b to at least partially process a transaction. The controller agent 122b may approve or deny the request based on the actions 204a and respond to the application 104b with an approval or denial. The application 104b may then process the transaction or refrain from processing the transaction based on the response received from the controller agent 122b. Embodiments are not limited in these contexts.

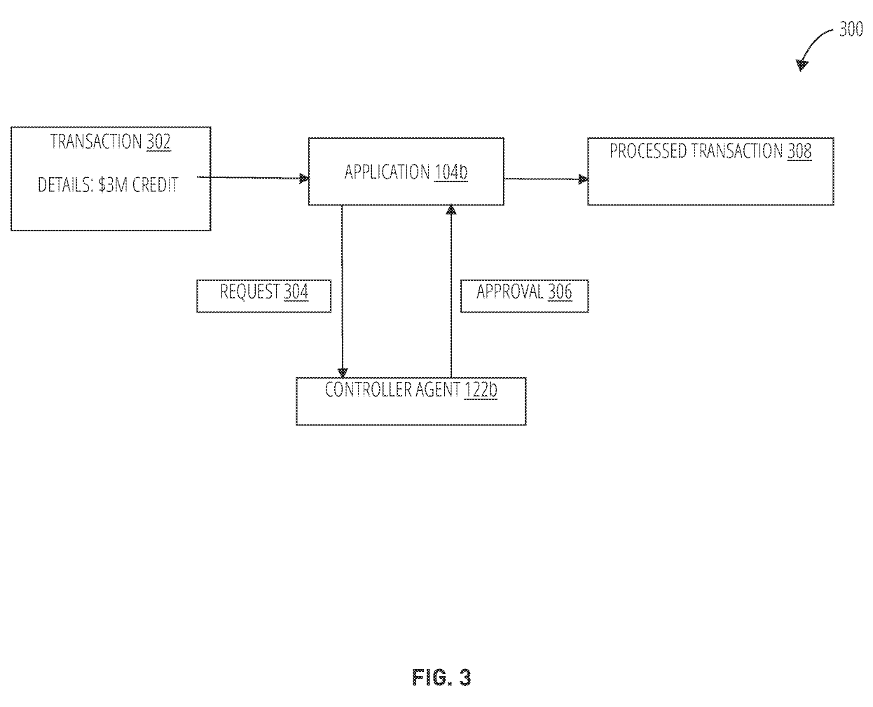

FIG. 3 is a schematic 300 illustrating an example of programmatically enforcing system-wide parameters in the system 100, according to one embodiment.

As shown, application 104b may receive an indication of a transaction 302. As shown, the transaction 302 is associated with a $3M credit to an account (e.g., $3M will be received by the account). The application 104b may generate a request 304 based on the transaction 302. The request 304 may include metadata associated with the transaction 302, including but not limited to the parties, the type of transfer, the direction of the transfer, the amount of the transfer, etc. The controller agent 122b may receive the request 304 and process the same based on the various rules, thresholds, priorities, and/or instructions applicable to the request 304. In some embodiments, the controller agent 122b processes the request 304 based on the translations 120 (not pictured), as the request 304 may be in a format specific to the application 104b. Doing so allows the controller agent 122b to communicate with different types of applications and/or systems.

For example, the application 104b may be associated with a threshold of $10M for a given transaction. Similarly, a global liquidity threshold may apply to the transfer. The controller agent 122b may determine that processing the $3M transfer would not violate the liquidity threshold. Therefore, since the $3M transaction does not exceed the $10M threshold and processing the transfer would not violate the liquidity threshold, the controller agent 122b may determine to approve the transaction 302. The controller agent 122b may then transmit an approval 306 to the application 104b. In some embodiments, the controller agent 122b generates the approval 306 based on the translations 120, e.g., to create an indication of the approval 306 that is consumable by the application 104b. The application 104b may then process the transaction 302 based on receiving the approval 306, thereby resulting in a processed transaction 308. Doing so ensures the various rules, parameters, and thresholds applicable to the system 100 are enforced. Embodiments are not limited in these contexts.

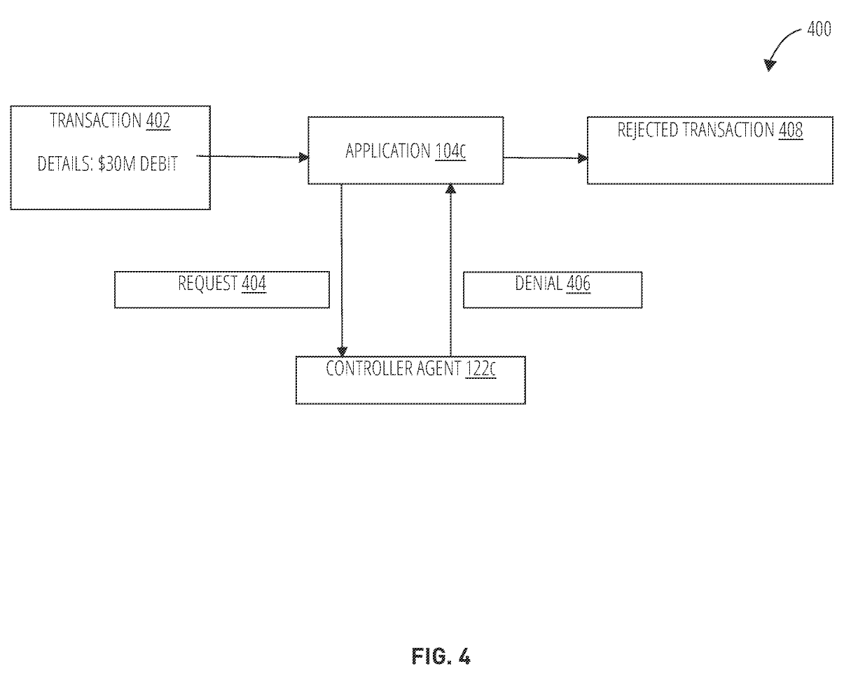

FIG. 4 is a schematic 400 illustrating an example of programmatically enforcing system-wide parameters in the system 100, according to one embodiment.

As shown, application 104c may receive an indication of a transaction 402. As shown, the transaction 302 is associated with a $30M debit from an account (e.g., $30M will be transferred out of the account). The application 104c may generate a request 404 based on the transaction 402. The request 404 may include metadata associated with the transaction 402, including but not limited to the parties, the type of transfer, the direction of the transfer, the amount of the transfer, etc. The controller agent 122c may receive the request 404 and process the same based on the various rules, thresholds, priorities, and/or instructions applicable to the request 404. In some embodiments, the controller agent 122c processes the request 404 based on the translations 120 (not pictured), as the request 304 may be in a format specific to the application 104c. Doing so allows the controller agent 122c to communicate with different types of applications and/or systems.

For example, the application 104c may be associated with a threshold of $10M for a given transaction. Similarly, a global liquidity threshold may apply to the transfer. The controller agent 122c may determine that processing the $30M transfer would violate the liquidity threshold. Therefore, since the $30M transaction exceeds the $10M threshold and processing the transfer would violate the liquidity threshold, the controller agent 122c may determine to reject the transaction 402. The controller agent 122c may then transmit a denial 406 to the application 104d. In some embodiments, the controller agent 122c generates the denial 406 based on the translations 120, e.g., to create an indication of the denial 406 that is consumable by the application 104c. The application 104c may then refrain from processing (or otherwise reject) the transaction 402 based on receiving the denial 406, thereby resulting in a rejected transaction 408. Doing so ensures the various rules, parameters, and thresholds applicable to the system 100 are enforced. Embodiments are not limited in these contexts.

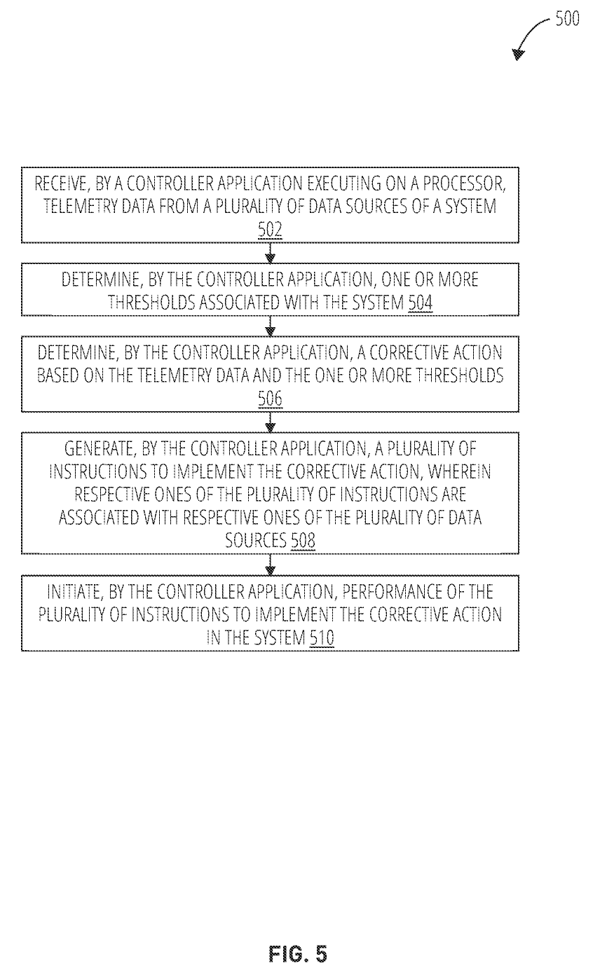

FIG. 5 illustrates an example logic flow 500 for programmatically enforcing system-wide parameters. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

According to some examples, the logic flow 500 includes receiving, by a controller application executing on a processor, telemetry data from a plurality of data sources of a system at block 502. For example, the controller 110 illustrated in FIG. 1 may receive telemetry data from a plurality of data sources of a system. For example, the controller agents 122a-122d may collect telemetry data and transmit the telemetry data to the controller 110. The telemetry data may reflect transactions and associated metadata.

According to some examples, the logic flow 500 includes determining, by the controller application, one or more thresholds associated with the system at block 504. For example, the controller 110 illustrated in FIG. 1 may determine one or more thresholds associated with the system. For example, the controller 110 may determine one or more thresholds in the configuration 118.

According to some examples, the logic flow 500 includes determining, by the controller application, a corrective action based on the telemetry data and the one or more thresholds at block 506. For example, the controller 110 illustrated in FIG. 1 may determine corrective action based on the telemetry data and the one or more thresholds. The corrective action may be any type of action, such as applying thresholds, applying rules, applying transaction prioritization, controlling application execution, controlling system performance, executing code or other instructions, and the like.

According to some examples, the logic flow 500 includes generating, by the controller application, a plurality of instructions to implement the corrective action, wherein respective ones of the plurality of instructions are associated with respective ones of the plurality of data sources at block 508. For example, the controller 110 illustrated in FIG. 1 may generate a plurality of instructions to implement the corrective action, wherein respective ones of the plurality of instructions are associated with respective ones of the plurality of data sources. For example, if the corrective action is to modify one or more features of each of the applications 104a-104d, the controller 110 may generate instructions that can be consumed by the respective application 104a-104d to modify the feature. As another example, the corrective action may be to apply a threshold. In such an example, the controller 110 may generate instructions that can be consumed by the respective application 104a-104d to apply a threshold.

According to some examples, the logic flow 500 includes initiating, by the controller application, performance of the plurality of instructions to implement the corrective action in the system at block 510. For example, the controller 110 illustrated in FIG. 1 may initiate performance of the plurality of instructions to implement the corrective action in the system by transmitting indications of the instructions to one or more recipients. For example, the controller 110 may transmit the instructions generated at block 508 to one or more recipients, such as the applications 104a-104d, servers 102, payment processing systems 108, user devices 112, and/or third party systems 114.

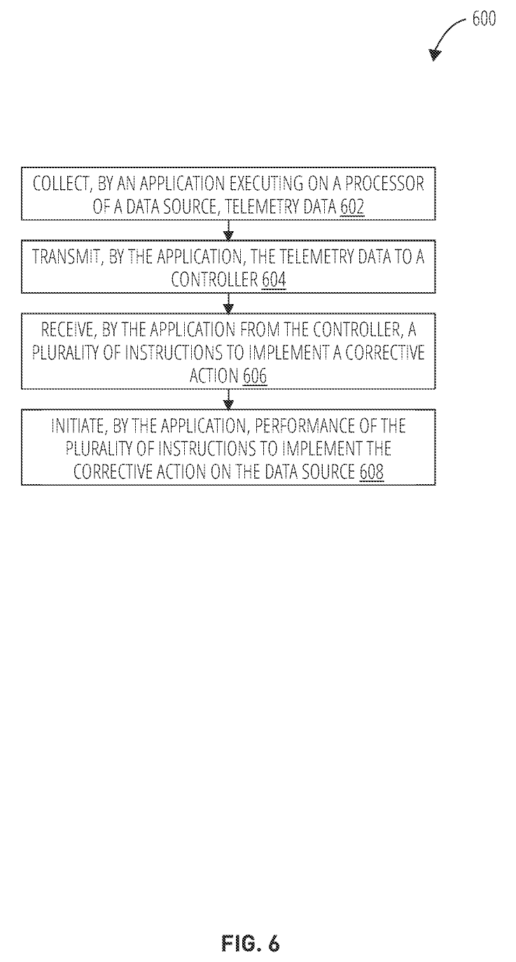

FIG. 6 illustrates an example logic flow 600 for programmatically enforcing system-wide parameters. Although the example logic flow 600 depicts a particular sequence of operations, the sequence may be altered without departing from the scope of the present disclosure. For example, some of the operations depicted may be performed in parallel or in a different sequence that does not materially affect the function of the logic flow 600. In other examples, different components of an example device or system that implements the logic flow 600 may perform functions at substantially the same time or in a specific sequence.

According to some examples, the logic flow 600 includes collecting, by an application executing on a processor of a data source, telemetry data at block 602. For example, the controller agents 122a-122d may collect telemetry data and transmit the telemetry data to the controller 110. The telemetry data may reflect transactions and associated metadata.

According to some examples, the logic flow 600 includes transmitting, by the application, the telemetry data to a controller at block 604. For example, the controller agent 122a illustrated in FIG. 1 may transmit the telemetry data to a controller such as controller 110.

According to some examples, the logic flow 600 includes receiving, by the application from the controller, a plurality of instructions to implement a corrective action at block 606. For example, the controller agent 122a illustrated in FIG. 1 may receive, from the controller 110, a plurality of instructions to implement a corrective action.

According to some examples, the logic flow 600 includes initiating, by the application, performance of the plurality of instructions to implement the corrective action on the data source at block 608. For example, the controller agent 122a illustrated in FIG. 1 may initiate performance of the plurality of instructions to implement the corrective action on the data source, e.g., by initiating execution of the instructions.

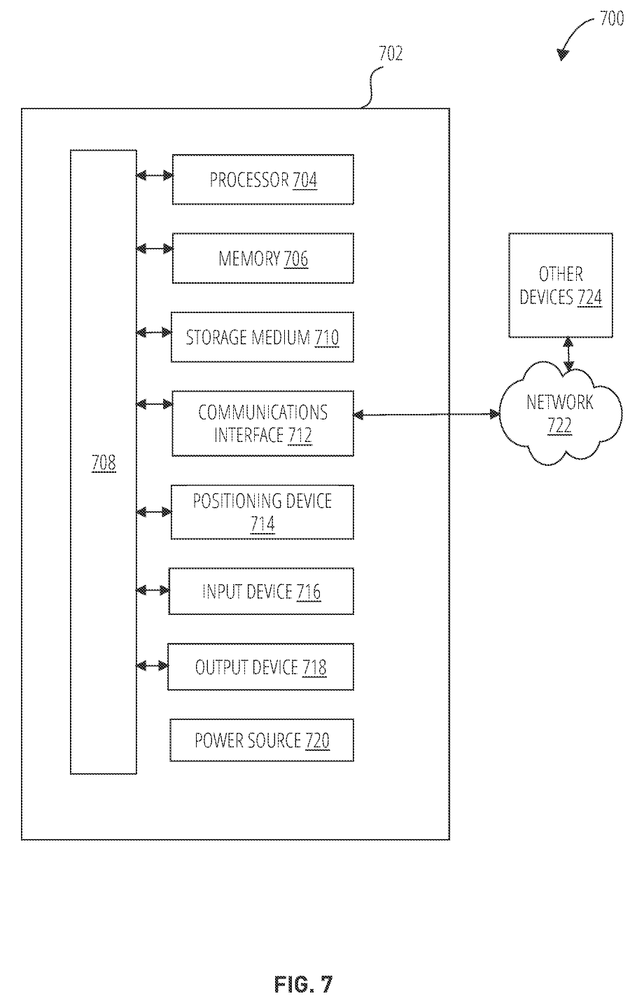

FIG. 7 illustrates an example computing system 700 suitable for implementing various embodiments as described herein. As shown, the computing system 700 comprises a computer 702, which is representative of any type of physical and/or virtualized computing device. Examples of the computer 702 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), or any other device with processing capabilities. In one embodiment, the computer 702 is representative of some or all of the components of the servers 102, payment processing systems 108, user devices 112, third party systems 114, and/or network 106.

As shown, the computer 702 includes one or more processors 704, one or more memories 706, one or more non-transitory storage media 710, one or more communications interfaces 712, one or more positioning devices 714, one or more input devices 716, and one or more output devices 718 communicably coupled via an interconnect 708. A power source 720, such as a power supply, battery, or any type of power source may provide power to the computer 702.

The processor 704 is representative of any type of processing circuit. For example, the processor 704 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 706 is representative of any computer readable medium to store data, code, or other information. The memory 706 may include volatile memory, such as volatile Random Access Memory (RAM) including a cache area for the temporary storage of data. The memory 706 may also include non-volatile memory, which can be embedded and/or may be removable. The non-volatile memory can additionally or alternatively include an electrically erasable programmable read-only memory (EEPROM), flash memory or the like. The storage medium 710 is representative of any type of computer readable medium to store data, code, or other information. Examples of storage media 710 include solid state drives, hard drives, Redundant Array of Independent Disks (RAID) drives, memory pools, USB storage devices, and the like.

The memory 706 and storage medium 710 can store any number and type of computer-executable instructions executed by the processor 704 to implement the functions of the computer 702 described herein. For example, the memory 706 may include such applications as a web browser application and/or a mobile P2P payment system client application. These applications also typically provide a graphical user interface (GUI) on a display that allows the user to communicate with the computer 702, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 706 and/or storage medium 710 may be used to store data such as cached data, files for user accounts, user profiles, account balances, transaction histories, files downloaded or received from other devices, and any other data items.

The interconnect 708 is representative of any type of circuitry to connect the components of the computer 702. For example, the interconnect 708 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 704 to the memory 706, individual electrical connections among the components, and electrical conductive traces on a motherboard common to some or all of the above-described components of the computer 702. As discussed herein, the interconnect 708 may operatively couple various components with one another, or in other words, electrically connects those components, either directly or indirectly – by way of intermediate component(s) - with one another.

The one or more input devices 716 are representative of any type of input device for receiving input, such as a keypad, keyboard, touch-screen, touchpad, microphone, camera, fingerprint sensor, mouse, joystick, other pointer device, button, soft key, and the like. The one or more output devices 718 are representative of any type of device for outputting information, such as a monitor, speaker, haptic feedback module, printer, and the like.

The computer 702 may use the communications interface 712 to communicate with one or more other devices 724 via a network 722. The communications interface 712 allows the computer 702 to communicate with and conduct transactions with other devices and systems, such as the other devices 724. The communications interface 712 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 712, which can be or include a radio-frequency transceiver, a Bluetooth device, Wi-Fi device, a Near-Field Communication (NFC) device, and other wireless transceivers. In addition, a positioning device 714 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 712, e.g., using USB, Ethernet, and other physically connected modes of data transfer. The network 722 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 702 is configured to use the communications interface 712 as, for example, a network interface to communicate with one or more other devices on a network such as network 722. In this regard, the computer 702 utilizes the wireless communications interface 712 as an antenna operatively coupled to a transmitter and a receiver (together a “transceiver”) included with the communications interface 712. The communications interface 712 is configured to provide signals to and receive signals from the transmitter and receiver, respectively. The signals may include signaling information in accordance with the air interface standard of the applicable cellular system of a wireless telephone network. In this regard, the computer 702 may be configured to operate with one or more air interface standards, communication protocols, modulation types, and access types. By way of illustration, the computer 702 may be configured to operate in accordance with any of a number of first, second, third, fourth, fifth-generation communication protocols and/or the like. For example, the as a smartphone, the computer 702 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 702 may also be configured to operate in accordance with non-cellular communication mechanisms, such as via a wireless local area network (WLAN) or other communication/data networks.

The communications interface 712 may also include a payment network interface. The payment network interface may include software, such as encryption software, and hardware, such as a modem, for communicating information to and/or from one or more devices on a network. For example, the computer 702 may be configured so that it can be used as a credit or debit card by, for example, wirelessly communicating account numbers or other authentication information to a terminal of the network. Such communication could be performed via transmission over a wireless communication protocol such as the NFC protocol.

The computer 702 may be under the control of any suitable operating system (not pictured). Example operating systems include, but are not limited to, Linux® operating systems, UNIX®, Windows® operating systems, macOS®, iOS®, Android® and any other type of operating system.

The computer 702 as illustrated diagrammatically represents at least one example of a possible implementation, where alternatives, additions, and modifications are possible for performing some or all of the described methods, operations and functions. Although shown separately, in some embodiments, two or more computers 702, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by a controller application executing on a processor, telemetry data from a plurality of data sources of a system;
determining, by the controller application, one or more thresholds associated with the system;
determining, by the controller application, an action based on the telemetry data and the one or more thresholds;
generating, by the controller application, a plurality of instructions to implement the action, wherein respective ones of the plurality of instructions are associated with respective ones of the plurality of data sources; and
initiating, by the controller application, performance of the plurality of instructions to implement the action in the system.

2. The method of claim 1, wherein the telemetry data comprises data describing a plurality of transactions processed by the system, wherein the thresholds comprise one or more monetary thresholds.

3. The method of claim 2, further comprising:
determining, by the controller application, a liquidity of the system based on a respective monetary amount of each of the plurality of transactions;
determining, by the controller application, the liquidity of the system exceeds at least one of the monetary thresholds; and
determining, by the controller application based on the liquidity of the system exceeding at least one of the monetary thresholds, the action comprises permitting another transaction, restricting the another transaction, or prioritizing the another transaction.

4. The method of claim 3, further comprising:
determining, by the controller application based on a type of a first data source of the plurality of data sources, a specific instruction to implement the action by the first data source; and
transmitting, by the controller application to the first data source, the specific instruction to implement the action by the first data source.

5. The method of claim 2, further comprising:
determining, by the controller application, a number of transactions processed by a first data source of the plurality of data sources during a first time interval;
determining, by the controller application, the number of transactions processed by the first data source during the first time interval exceeds at least one of the thresholds; and
determining, by the controller application based on the determination that the number of transactions processed by the first data source during the first time interval exceeds at least one of the thresholds, that the action comprises restricting the first data source from processing at least one transaction during a second time interval, the second time interval subsequent to the first time interval.

6. The method of claim 1, further comprising:
receiving, by the controller application, a new threshold; and
storing, by the controller application, the new threshold in a data store including the one or more thresholds.

7. The method of claim 1, wherein the system comprises a payment processing system, wherein the plurality of data sources comprise: (i) a plurality of computing systems in the payment processing system, and (ii) a plurality of applications executing in the payment processing system.

8. A non-transitory computer-readable storage medium, the computer-readable storage medium including instructions that when executed by a processor, cause the processor to:
receive, by a controller application, telemetry data from a plurality of data sources of a system;
determine, by the controller application, one or more thresholds associated with the system;
determine, by the controller application, an action based on the telemetry data and the one or more thresholds;
generate, by the controller application, a plurality of instructions to implement the action, wherein respective ones of the plurality of instructions are associated with respective ones of the plurality of data sources; and
initiate, by the controller application, performance of the plurality of instructions to implement the action in the system.

9. The computer-readable storage medium of claim 8, wherein the telemetry data comprises data describe a plurality of transactions processed by the system, wherein the thresholds comprise one or more monetary thresholds.

10. The computer-readable storage medium of claim 9, wherein the instructions further cause the processor to:
determine, by the controller application, a liquidity of the system based on a respective monetary amount of each of the plurality of transactions;
determine, by the controller application, the liquidity of the system exceeds at least one of the monetary thresholds; and
determine, by the controller application based on the liquidity of the system exceeding at least one of the monetary thresholds, the action comprises permitting another transaction, restricting the another transaction, or prioritizing the another transaction.

11. The computer-readable storage medium of claim 10, wherein the instructions further cause the processor to:
determine, by the controller application based on a type of a first data source of the plurality of data sources, a specific instruction to implement the action by the first data source; and
transmit, by the controller application to the first data source, the specific instruction to implement the action by the first data source.

12. The computer-readable storage medium of claim 9, wherein the instructions further cause the processor to:
determine, by the controller application, a number of transactions processed by a first data source of the plurality of data sources during a first time interval;
determine, by the controller application, the number of transactions processed by the first data source during the first time interval exceeds at least one of the thresholds; and
determine, by the controller application based on the determination that the number of transactions processed by the first data source during the first time interval exceeds at least one of the thresholds, that the action comprises restricting the first data source from processing at least one transaction during a second time interval, the second time interval subsequent to the first time interval.

13. The computer-readable storage medium of claim 8, wherein the instructions further cause the processor to:
receive, by the controller application, a new threshold; and
store, by the controller application, the new threshold in a data store including the one or more thresholds.

14. The computer-readable storage medium of claim 8, wherein the system comprises a payment processing system, wherein the plurality of data sources comprise: (i) a plurality of computing systems in the payment processing system, and (ii) a plurality of applications executing in the payment processing system.

15. An apparatus, comprising:
a processor; and
a memory storing instructions that, when executed by the processor, cause the processor to:
receive, by a controller application, telemetry data from a plurality of data sources of a system;
determine, by the controller application, one or more thresholds associated with the system;
determine, by the controller application, an action based on the telemetry data and the one or more thresholds;
generate, by the controller application, a plurality of instructions to implement the action, wherein respective ones of the plurality of instructions are associated with respective ones of the plurality of data sources; and
initiate, by the controller application, performance of the plurality of instructions to implement the action in the system.

16. The apparatus of claim 15, wherein the telemetry data comprises data describe a plurality of transactions processed by the system, wherein the thresholds comprise one or more monetary thresholds.

17. The apparatus of claim 16, wherein the instructions further cause the processor to:
determine, by the controller application, a liquidity of the system based on a respective monetary amount of each of the plurality of transactions;
determine, by the controller application, the liquidity of the system exceeds at least one of the monetary thresholds; and
determine, by the controller application based on the liquidity of the system exceeding at least one of the monetary thresholds, the action comprises permitting another transaction, restricting the another transaction, or prioritizing the another transaction.

18. The apparatus of claim 17, wherein the instructions further cause the processor to:
determine, by the controller application based on a type of a first data source of the plurality of data sources, a specific instruction to implement the action by the first data source; and
transmit, by the controller application to the first data source, the specific instruction to implement the action by the first data source.

19. The apparatus of claim 16, wherein the instructions further cause the processor to:
determine, by the controller application, a number of transactions processed by a first data source of the plurality of data sources during a first time interval;
determine, by the controller application, the number of transactions processed by the first data source during the first time interval exceeds at least one of the thresholds; and
determine, by the controller application based on the determination that the number of transactions processed by the first data source during the first time interval exceeds at least one of the thresholds, that the action comprises restricting the first data source from processing at least one transaction during a second time interval, the second time interval subsequent to the first time interval.

20. The apparatus of claim 15, wherein the instructions further cause the processor to:
receive, by the controller application, a new threshold; and
store, by the controller application, the new threshold in a data store including the one or more thresholds.
